(19) United States
(12) Patent Application Publication
(10) Pub. No.: US 2026/0307237 A1
(43) Pub. Date: Oct. 8, 2026

(54) Tool Cover

(71) Applicant: Lance Industries, Inc., Madison Heights, MI (US)

(72) Inventors: Jacob William Floore, Madison Heights, MI (US); Robert Edward Davis, Madison Heights, MI (US)

(73) Assignee: Lance Industries, Inc., Madison Heights, MI (US)

(21) Appl. No.: 19/632,266

(22) Filed: Mar. 28, 2026

Related U.S. Application Data
(60) Provisional application No. 63/782,296, filed on Apr. 2, 2025.

(51) Int. Cl. B25H 3/00

(52) U.S. Cl. CPC B25H 3/006

(57) ABSTRACT

A tool cover is provided having a one piece unitary body of resilient elastomeric material having a tubular body configured to receive a tool and a loop integrally formed from and extending outwardly of the body configured to support the cover and an encased tool from a hanger at a work station.

### RELATED DATA

This utility patent application claims priority to U.S. Provisional Patent Application Serial No. 63/782,296, filed Apr. 2, 2025, entitled “Tool Cover”, the disclosures of which are incorporated herein by reference.

### TECHNICAL FIELD

The technical field relates generally to devices and methods for protecting and retaining a tool during an assembly operation in a manufacturing operation. More particularly, the technical field pertains to protective tool covers having support structures and methods for manufacturing.

### BACKGROUND OF THE DISCLOSURE

Automated industrial lines, such as vehicle assembly lines, are operated to join together painted or surface finished assemblies to which sub-assemblies are affixed with fasteners. In the process of affixing, there has long been a risk of scratching or denting the finished or painted portions of an assembly. Electric, pneumatic and battery powered tools have long been protected with protective heads or covers of resilient material to mitigate scratching of such surfaces in use during a fastening operation. However, staging and storage of such covered tools has posed a problem. One solution used for the past 15 years has been to affix D-rings or S-hooks onto a covered tool to provide a hanger for storing the tool when not in use at a staging location between uses. However, D-rings and S-hooks are affixed to a covered tool using nylon cable ties and trimmed cable tie ends and ratchet head ends form likely locations and projections to scratch a vehicle surface. Accordingly, improvements are needed in protecting a finished assembly surface from scratching and denting during tool use and stowage of the tool between uses.

### SUMMARY OF THE INVENTION

A tool cover is provided for use on a tool when securing together components on an automated industrial line, or a vehicle assembly line in order mitigate risk from scratches and/or dents and to facilitate stowage between uses.

According to one aspect, a tool cover is provided having a one piece unitary body of resilient elastomeric material having a tubular body configured to receive a tool and a loop integrally formed from and extending outwardly of the body configured to support the cover and an encased tool from a hanger at a work station.

According to another aspect, a tool cover is provided being a unitary component. The tool cover includes a tubular body and a loop. The tubular body is of resilient elastomeric material configured to receive a tool. The loop is integrally formed from and extending outwardly of the tubular body of resilient elastomeric material and is configured to support the cover and an encased tool from a hanger at a work station.

### BRIEF DESCRIPTION OF THE DRAWINGS

FIG. 1 is a perspective view of tool cover for a handheld assembly line tool carried by an overhead hanger assembly for storage between uses.

FIG. 2 is a perspective view from above and behind of the tool cover of FIG. 1.

FIG. 3 is a left side view of the tool cover of FIG. 1.

FIG. 4 is a vertical sectional view of the tool cover taken along line 4-4 of FIG. 2.

FIG. 5 is a vertical sectional view of the tool cover taken along line 5-5 of FIG. 2.

FIG. 6 is a top view from above, rotated 180 degrees, of the tool cover of FIG. 2.

FIG. 7 is a bottom view from below, rotated 180 degrees, of the tool cover of FIG. 2.

FIG. 8 is a right side view of the tool cover of FIG. 1.

FIG. 9 is front end view of the tool cover of FIG. 3 taken from a left end.

FIG. 10 is a rear end view of the tool cover of FIG. 3 taken from a right end.

### DETAILED DESCRIPTION OF THE EMBODIMENTS

This disclosure is submitted in furtherance of the constitutional purposes of the U.S. Patent Laws “to promote the progress of science and useful arts” (Article 1, Section 8).

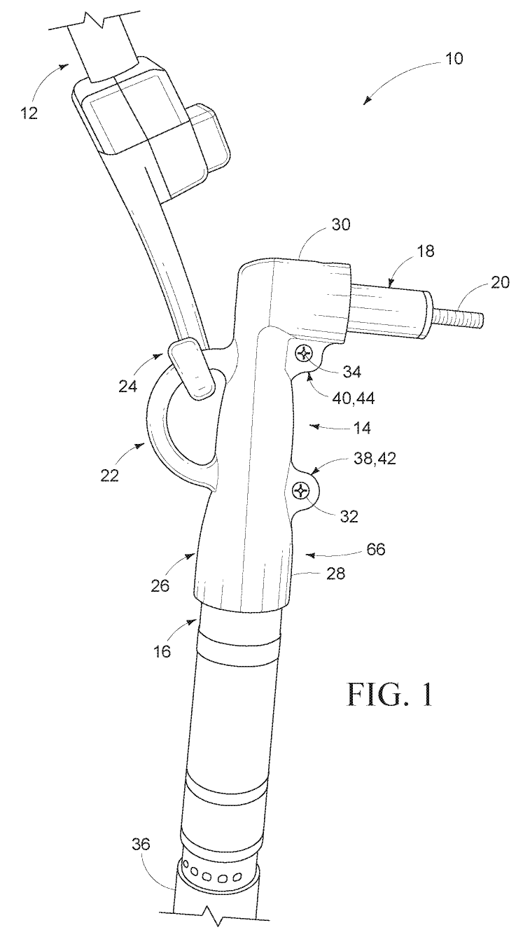

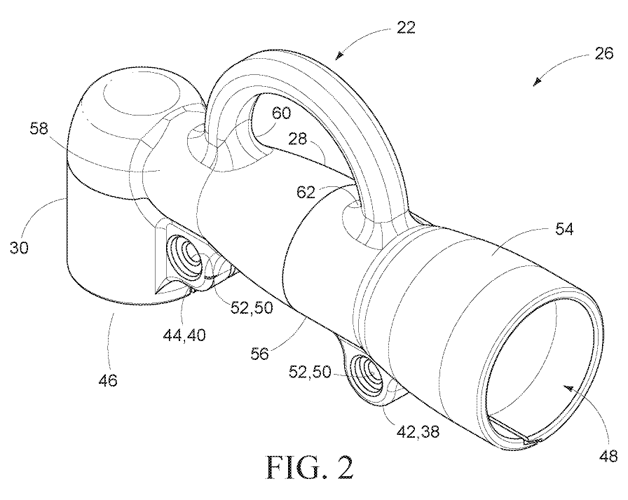

FIG. 1 is a perspective view of tool cover 26 for a handheld assembly line tool 16 that forms a covered tool assembly 14 carried by an overhead hanger assembly and suspension cable 12 of a tool station 10 for storage between uses. Tool 16 is known as a right angle nut runner. Optionally, tool cover 26 can be configured to cover a tubular body portion of a pistol grip nut runner, or even portions of a pistol grip handle, and further including any frame around a rear user interface provided on the pistol grip nut runner. More particularly, cover 26 for tool 16 includes a hanger in the form of a ring, or loop 22 integrally formed into cover 26 and positioned to support tool 16 and cover 26 at a workstation location via a J-hook 24 on a tool hanger assembly 12. Optionally, hanger 22 can be an open loop, or hook made with a resilient material that won't scratch or dent a vehicle surface, possibly including an internal structure. Cover 26 includes a tubular longitudinal body 28 contiguously forming ring, or loop 22 and integral with a tubular head 30. Cover 26 is formed from a flexible resilient material that mitigates risk of generating scratches or dings to finished portions on an assembly, such as a painted vehicle body panel during an assembly operation. A longitudinal slit, or slot 66 enables assembly of cover 26 over a tool 16 and aligned and mating pairs of screw bosses, or fastener flanges 38, 42 and 40,44 are secured together via individual fasteners 32 and 34 to secure cover 26 onto tool 16. A protector socket (covered with a non-marring plastic sleeve) 18 is shown mounted to tool 16 extending from a tool opening 46 (see FIG. 2) and loaded with a fastener as placed during an assembly step. Socket 18 is covered with a resilient material to protect against dings and scratches to a finished, or painted surface. Power to tool 16 is delivered via a DC powerline 36 from a supply source (not shown).

As shown in FIG. 1, fasteners 32 and 34 according to one construction comprise a binding barrel and screw assembly, such as a Z4438PAK part No. 98002A312, 8/32" stainless steel binding barrel and screw for 1/2" to 5/8" thick material available from McMaster-Carr, 9630 Norwalk Blvd Santa Fe Springs CA 90670-2932 or online at https://www.mcmaster.com. However, other fasteners or numbers of fasteners can also be used such as screws, bolts and nuts, rivets, or any other form of physical fastener.

FIG. 2 is a perspective view from above and behind of the tool cover 26 of FIG. 1. More particularly, tool cover 26 is shown in a one-piece, unitary construction with tubular body portion 28, head portion 30, and loop 22 formed together from a single material. One suitable material is a thermoplastic polyurethane (TPU) capable of being formed with a 3D printing process. Optionally, any other suitable urethane, plastic, polyurethane, or other structural and/or cover material suitable for making a dent and scratch resistant cover having sufficient elasticity can be used for cover 26.

According to one construction, the resilient elastomeric material of FIG. 2 has a shore hardness in a range from about A90 to about A95. According to another construction, the resilient elastomeric material has a shore hardness of about A95. According to either the one construction or the another construction, the resilient elastomeric material can be a thermoplastic polyurethane (TPU) capable of being formed with a 3D printing process. According to one construction, the resilient elastomeric material has uniform properties including shore hardness. According to another construction, an outer contact surface has a shore hardness less than an inner portion of the cover.

As shown in FIG. 2, head portion 30 of tool cover 26 has an open end 46 for accessing a socket (not shown) and a closed opposite end 58. Tubular body portion 28 extends from a distal end from head portion 30 and has an open end 48 through which a tool and DC power line extend. Tubular body portion 28 includes an enlarged bell portion 54 adjacent opening 48 transitioning contiguously into a medial bell portion 56 and a socket bell portion 58 adjacent head portion 30. Furthermore, screw bosses 42,38 and 44, 40 each have a recessed compound fastener bore 52, 50, respectively, sized to receive portions of fasteners 32 and 34 comprising a binding barrel and screw assembly such that such components are recessed and not exposed for contact with any finished or painted surfaces. Finally, loop 22 is integrally formed with tubular body portion 28 with flared circumferential and radiused transition regions 60 and 62.

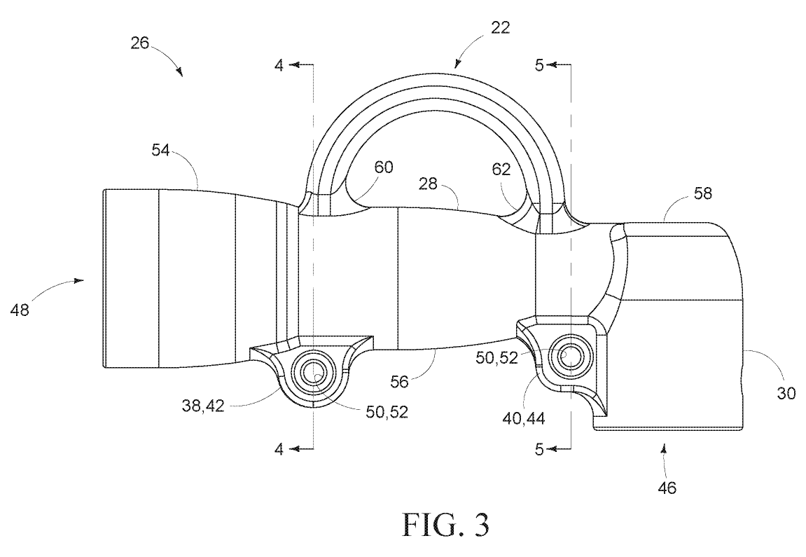

FIG. 3 is a left side view of the tool cover 26 of FIG. 1 showing tubular body portion 28, comprising bell portions 54 and 56 and end portion 58 extending from open end 48 to end portion 58 adjacent head portion 30. Ring 22 is integrally formed from body portion 28 via flared transition regions 60 and 62. Recessed fastener bores 50 and 52 in screw bosses 38,42 and 40,44 are clearly shown for receiving fasteners that will not project from cover 26.

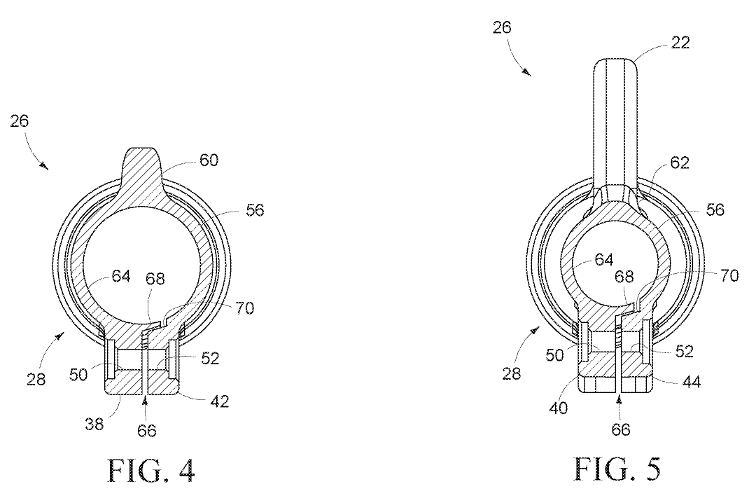

FIG. 4 is a vertical sectional view of the tool cover 26 taken along line 4-4 of FIG. 2 near radiused transition region 60. Inner wall 64 increases in diameter as mid bell portion 56 of elongate body portion 28 increases in dimension and conforms to an outer surface shape of a power tool encased therein (not shown), and also extends within head portion 30 to terminate at opening 46 (see FIG. 3). A longitudinal slit, or slot 66 is provided along elongate body portion 28 to facilitate insertion of a tool 16 within inner wall 64 and head portion 30 (see FIG. 1). Slot 66 cooperates with opposed overlapping flaps 68 and 70 to form a fully covered seam along body portion 28 and a slight offset gap between flaps 68 and 70 enables reduction in diameter about a received tool body as a fastener (binding barrel and screw assembly 34, see FIG. 1) are secured within bores 50 and 52 of flanges 38 and 42.

FIG. 5 is a vertical sectional view of the tool cover 26 taken along line 5-5 of FIG. 2 near radiused transition region 62 on loop 22. Slot 66 cooperates with flaps 68 and 70 to ensmall an inner diameter of inner wall 64 as shown in mid bell portion 56 of longitudinal body portion 28. A fastener (binding barrel and screw assembly 32, see FIG. 1) is secured within bores 50 and 52 of flanges 40 and 44.

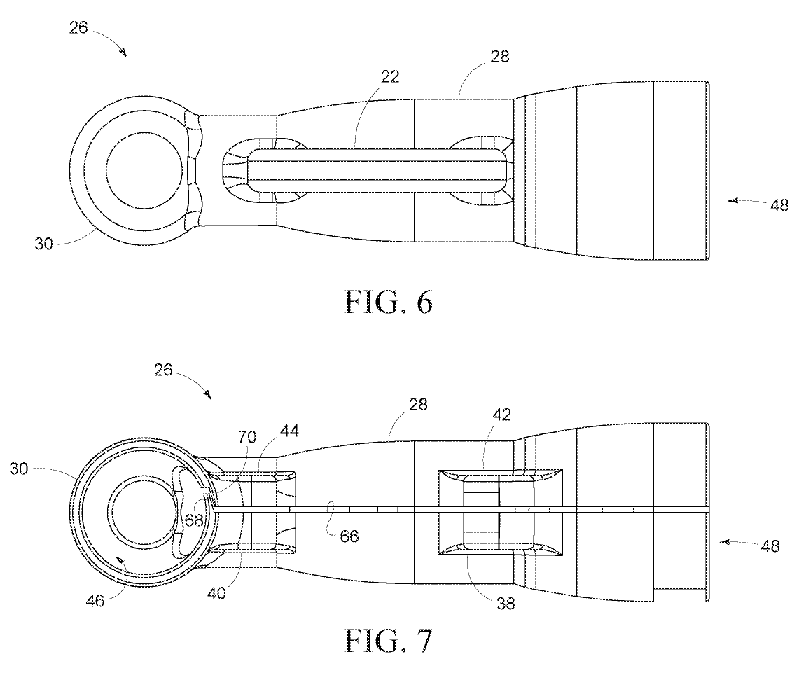

FIG. 6 is a top view from above, rotated 180 degrees, of the tool cover 26 of FIG. 2. Ring, or loop 22 integrally formed atop elongate body portion 28 which extends from a tool and power supply opening 48 to heat portion 30.

FIG. 7 is a bottom view from below, rotated 180 degrees, of the tool cover 26 of FIG. 2. Slot 66 forms a gap in elongate body portion 28 and head portion 28 extending from opening 48 through head portion 30. In assembly, elongate body portion 28 and head portion 30 are flexibly opened while inserting a tool 16 (see FIG. 1), such as a DC powered socket wrench, within openings, or cavities 46 and 48. Fastener flanges 38, 42 and 40,44 are then drawn together, closing and inter-nesting flaps 68 and 70 as fasteners 32 and 34 (binding barrel and screw assemblies, see FIG. 1) are secured and tightened within bores through each pair 38, 42 and 40, 44.

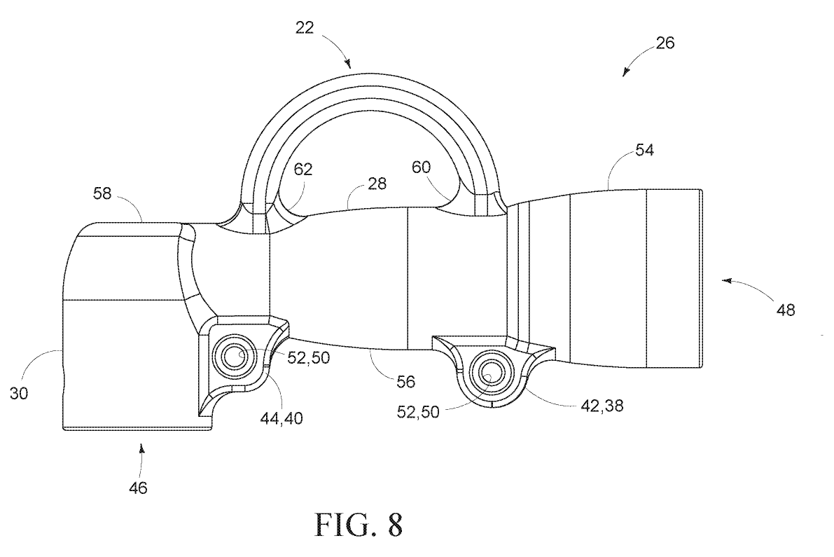

FIG. 8 is a right side view of the tool cover 26 of FIG. 3 showing tubular body portion 28, comprising bell portions 54 and 56 and end portion 58 extending from open end 48 to end portion 58 adjacent head portion 30 which terminates in socket opening 46. Ring 22 is integrally formed from body portion 28 via flared transition regions 60 and 62. Recessed fastener bores 52,50 in screw bosses 42,38 and 44,40 are shown for receiving fasteners 34 and 32 (see FIG. 1) that will not project from cover 26.

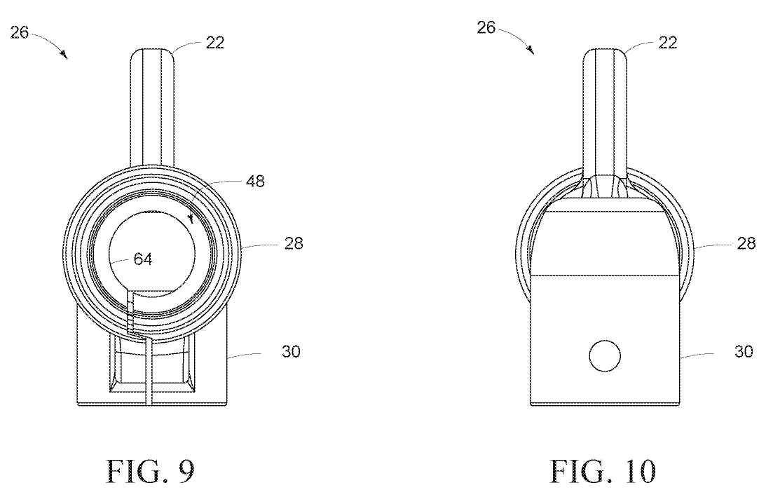

FIG. 9 is front end view of the tool cover 26 of FIG. 3 taken from a left end and showing power line and tool opening 48 formed within inner wall 64 of elongate body portion 28. Elongate body portion 28 at a distal end contiguously terminates in head portion 30 and integrally forms D-ring, or loop 22 configured to hang a tool and cover assembly.

FIG. 10 is a rear end view of the tool cover 26 of FIG. 3 taken from a right end. D-ring, or loop 22 is formed contiguously with elongate body portion 28, which extends contiguously into head portion 30.

The terms “a”, “an”, and “the” as used in the claims herein are used in conformance with long-standing claim drafting practice and not in a limiting way. Unless specifically set forth herein, the terms “a”, “an”, and “the” are not limited to one of such elements but instead mean “at least one”.

In compliance with the statute, the various embodiments have been described in language more or less specific as to structural and methodical features. It is to be understood, however, that the various embodiments are not limited to the specific features shown and described, since the means herein disclosed comprise disclosures of putting the various embodiments into effect. The various embodiments are, therefore, claimed in any of its forms or modifications within the proper scope of the appended claims appropriately interpreted in accordance with the doctrine of equivalents.

What is claimed is:

1. A tool cover, comprising:
a one piece unitary body of resilient elastomeric material having a tubular body configured to receive a tool and a loop integrally formed from and extending outwardly of the body configured to support the cover and an encased tool from a hanger at a work station.

2. The tool cover of claim 1, wherein the body comprises a tool shaped body configured to encase a power tool.

3. The tool cover of claim 2, wherein the tool shaped body comprises a unitary piece of resilient elastomeric covering having an inner wall configured to encase a tool, a power line opening configured to receive a power line at a first end, and a tool head opening spaced from the power line opening configured to receive a drive socket.

4. The tool cover of claim 3, further comprising a slit in the covering extending elongate along the tool shaped body configured to enable insertion of a tool within the tool shaped body and envelope the tool.

5. The tool cover of claim 4, further comprising an inner flap and an outer flap provided on opposite edges defining the slit configured to overlap in assembly.

6. The tool cover of claim 5, further comprising a pair of opposed fastener bosses, one fastener boss provided on each side of the slit, and a fastener configured to secure together the fastener bosses to retain the slit in an overlapped flap retained position.

7. The tool cover of claim 1, wherein the one piece unitary body comprises a thermoplastic polyurethane (TPU).

8. The tool cover of claim 7, wherein the one piece unitary body is formed with a 3D printing process.

9. A tool cover, the cover being a unitary component comprising:
a tubular body of resilient elastomeric material configured to receive a tool; and
a loop integrally formed from and extending outwardly of the tubular body of resilient elastomeric material and configured to support the cover and an encased tool from a hanger at a work station.

10. The tool cover of claim 9, wherein the tubular body comprises a tool shaped body configured to encase a power tool.

11. The tool cover of claim 10, wherein the tool shaped body comprises a unitary piece of resilient elastomeric covering integral with the loop and having an inner wall configured to encase a tool, a power line opening configured to receive a power line at a first end, and a tool head opening spaced from the power line opening configured to receive a drive socket.

12. The tool cover of claim 11, wherein the unitary piece of resilient elastomeric covering and the integral loop comprises a thermoplastic polyurethane (TPU).

13. The tool cover of claim 12, wherein the covering and the loop is formed integrally with a 3D printing process.

14. The tool cover of claim 9, wherein the resilient elastomeric material has a shore hardness in a range from about A90 to about A95.

15. The tool cover of claim 9, wherein the tubular body and the loop have a lower shore hardness on an outer surface portion than an inner portion.

16. The tool cover of claim 9, wherein the resilient elastic material of the tubular body and the integral loop have a shore durometer rating sufficient to mitigate scratching of a painted vehicle surface.

17. The tool cover of claim 9, further comprising a slit provided in the tubular body extending along the tool shaped body configured to enable insertion of a tool within the tool shaped body and envelope the tool.

18. The tool cover of claim 17, further comprising an inner flap and an outer flap provided on opposite edges of the tool shaped body defining the slit configured to overlap in assembly and opposed bores on opposed sides of the slit configured to receive a fastener to retain in overlap the inner flap and the outer flap against a tool.

19. The tool cover of claim 18, wherein the tool shaped body comprises an elongate body portion and a head portion cooperating to provide a contiguous inner wall for receiving a tool.

20. The tool cover of claim 19, wherein the loop is provided on an opposed side of the elongate body portion from a tool opening in the head portion.
